(19) United States
(12) Patent Application Publication
(10) Pub. No.: US 2023/0314386 A1
(43) Pub. Date: Oct. 5, 2023

(54) METHOD FOR CHARACTERIZING A PART THROUGH NON-DESTRUCTIVE INSPECTION

(71) Applicant: COMMISSARIAT A L'ENERGIE ATOMIQUE ET AUX ENERGIES ALTERNATIVES, Paris (FR)

(72) Inventors: Clement FISHER, Orsay (FR); Olivier MESNIL, Orsay (FR); Roberto MIORELLI, Gif-sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 18/042,087

(22) PCT Filed: Aug. 19, 2021
(86) PCT No.: PCT/EP2021/073061

§ 371 Date: Feb. 17, 2023

(30) Foreign Application Priority Data
Aug. 19, 2020 (FR) 2008564

(51) Int. Cl. G01N 29/44; G01N 21/88; G01N 27/90; G01N 25/72; G01N 23/18

(52) U.S. Cl. CPC G01N 29/4481; G01N 21/8851; G01N 27/90; G01N 25/72; G01N 23/18; G01N 2291/26

(57) ABSTRACT

A method is provided for characterizing a part includes: a) carrying out measurements using a sensor, the sensor being placed on the part or facing the part; b) forming at least one measurement matrix using the measurements performed in step a); c) using the matrix as input datum of a convolutional neural network including an extracting block, configured to extract features from each input datum; a classifying block, configured to classify the features extracted, the classifying block outputting to at least one node; and d) depending on each node, detecting the presence of a defect in the part. The neural network employed in step c) is established using the extracting block of another previously parametrized neural network.

### TECHNICAL FIELD

The technical field of the invention is interpretation of non-destructive-testing measurements carried out on a mechanical part or a portion of a structure.

### PRIOR ART

NDT, meaning non-destructive testing, consists in controlling the quality of parts or mechanical structures, using sensors, in a non-destructive way. The objective is to perform a test and/or to detect and monitor for the appearance of structural defects. This involves monitoring the integrity of a tested part, so as to prevent the occurrence of accidents, or to extend the time for which the part may be safely used.

NDT is commonly implemented on sensitive equipment, so as to optimize replacement or maintenance thereof. It has many applications to testing industrial equipment, for example in the petroleum industry, in the nuclear industry, or in the transportation field (aeronautics for example).

The sensors used in the NDT are non-destructive sensors that cause no damage to the tested parts. The tested parts may be structural elements of industrial equipment or aircraft, or of civil engineering works (bridges or dams for example). Various methods are implemented. They may for example employ X-rays, or ultrasonic waves or detection via eddy currents.

During use thereof, the sensors are connected to computing means, so as to make it possible to interpret the performed measurements. The presence of a defect, in a part, leads to a defect signature that is measurable by a sensor. The computing means perform an inversion. It is a question, based on the measurements, of obtaining quantitative data relating to the defect (for example its position, or its shape, or its dimensions).

The inversion may be carried out using direct analytical models (polynomial models for example) allowing a relationship to be established between the features of a defect and the measurements delivered by a sensor. The inversion of the model allows said features to be estimated based on the measurements carried out.

According to another approach, the features of the defects may be estimated using supervised artificial-intelligence algorithms, neural networks for example. However, one difficulty associated with use of neural networks is the need to perform a complete-as-possible training phase, to optimize the performance of the estimation. This takes time and requires a lot of data. The inventors have provided a method that addresses this problem. The objective is to make it easier to train a neural network intended to perform an inversion, while maintaining a good performance in respect of estimation of the features of the defect.

### SUMMARY OF THE INVENTION

A first subject of the invention is a method for characterizing a part, the part being liable to comprise a defect, the method comprising the following steps:
a) carrying out non-destructive measurements using a sensor, the sensor being placed on the part or facing the part;
b) forming at least one measurement matrix using the measurements performed in step a);
c) using the matrix as input datum of a convolutional neural network, the convolutional neural network comprising:
   an extracting block, configured to extract features from each input datum;
   a classifying block, configured to classify the features extracted by the extracting block, the classifying block outputting to an output layer comprising at least one node;
d) depending on the value of each node of the output layer, detecting the presence of a defect in the part, and potentially characterizing the detected defect;
   the method comprising, prior to steps c) and d):
constructing a first database, the first database comprising performed or simulated measurements, of a first model part, in a first configuration, the first configuration being parametrized by parameters, the first database being formed considering at least one variable parameter and at least one fixed parameter;
employing a first neural network, comprising an extracting block and a processing block, the processing block being configured to process features extracted by the extracting block, the first neural network having been the subject of a first training operation, using the first database;
   the method being characterized in that it also comprises:
constructing a second database, comprising performed or simulated measurements of a second model part that is representative of the characterized part, in a second configuration, the second configuration being parametrized by modifying at least one fixed parameter of the first configuration;
a second training operation, using the second database, so as to parametrize a second convolutional neural network, the second convolutional neural network comprising the extracting block of the first neural network, and a classifying block, the latter being parametrized in the second training operation;
such that in step c), the neural network used is the second convolutional neural network, resulting from the second training operation.

By measurement, what is meant is a measurement of a physical quantity liable to vary in the presence of a defect in the part. It may be an acoustic quantity, an electric quantity, an electrostatic quantity, a magnetic quantity, an electromagnetic quantity (for example an intensity of a type of radiation), or a mechanical quantity.

The second configuration may notably take into account:
a second model part different from the first model part;
and/or experimental measurements, whereas the first configuration takes in account simulated measurements, or vice versa;
and/or a defect shape different from the shape of the defect considered in the first model part;
and/or different measurement conditions with respect to the measurement conditions taken into account in the first configuration (for example type of sensor, temperature, humidity, measurement noise);
and/or a type of defect different from the type of defect taken into account in the first configuration.

The first database may comprise measurements performed or simulated on a model part comprising the defect.

According to one embodiment, the processing block of the first neural network is a classifying block, configured, in the first training operation, to perform a classification of the features extracted by the extracting block, the first neural network being a convolutional neural network. In the second training operation, the classifying block of the second neural network may be initialized using the classifying block of the first neural network.

According to one embodiment, the first neural network is an autoencoder. Said processing block of the first neural network may be configured, in the first training operation, to reconstruct data obtained from the first database, and forming input data of the first neural network.

The defect may be of the following type: delamination, and/or crack, and/or perforation and/or crack propagating from a perforation and/or presence of a porous region and/or presence of an inclusion and/or presence of corrosion.

The part may be made of a composite, comprising components assembled with one another. The defect may then be an assembly defect between the components.

The measurements may be representative of a spatial distribution:
of electrical or magnetic or mechanical properties of the part;
and/or of dimensions of the part;
and/or of properties of propagation of an acoustic or mechanical or electromagnetic wave through or along the part;
and/or of properties of reflection of an acoustic wave or mechanical wave or electromagnetic, notably visible or infrared, wave by the part;
and/or properties of transmission of an X-ray or gamma-ray electromagnetic wave by the part;
and/or of a temperature of the part.

The defect may be a variation in the spatial distribution with respect to a reference spatial distribution. The reference spatial distribution may have been previously modeled or established experimentally.

The measurements may be of the following type:
measurements of eddy currents formed in the part under the effect of excitation of the part by a magnetic field;
and/or measurements of propagation of acoustic or mechanical waves propagating through or along the part;
and/or measurements of the reflection of infrared or visible light when the part is illuminated by infrared or visible light;
and/or measurements of the transmission of X-ray or gamma radiation through the part when said part is irradiated by a source of X-ray or gamma radiation.

The method may be such that:
the first database is constructed from simulated measurements;
and the second database is formed from measurements performed experimentally;
   or
the first database is constructed from measurements performed experimentally;
and the second database is formed from simulated measurements;
   or
the first database and the second database are constructed from simulated measurements;
   or
the first database and the second database are constructed from experimental measurements.

The first configuration and the second configuration may be parametrized by at least one of the parameters chosen from:
type of measurement: experimental or simulated;
shape of the model part;
material forming the model part;
measurement conditions;
type of defect in question;
location of the defect in the model part;
shape of the defect in the model part;
at least one dimension of the defect of the model part.

The measurement conditions may comprise at least:
position of the sensor with respect to the model part and/or number of sensors;
temperature and/or humidity and/or environmental conditions under which the sensor is employed;
surface finish of the inspected part;
measurement noise level;
type of sensor used;
uncertainties associated with the measurements.

The first model part and the second model part may be identical.

According to one possibility:
the second model part has a different shape to the first model part;
and/or the second model part is formed from a different material to the first model part.

The second database may comprise a number of data lower than the number of data of the first database.

The characterization of the defect may comprise:
identification of the type of defect, among predetermined types;
and/or estimation of at least one dimension of the defect;
and/or location of the defect in the part;
and/or determination of a number of defects in the part.

The invention will be better understood on reading the examples of embodiment that are presented, in the rest of the description, with reference to the figures listed below.

### FIGURES

FIGS. 1A and 1B schematically show eddy-current-based measurements being taken on a conductive part.

FIG. 2A shows the structure of a convolutional neural network.

FIG. 2B shows the main steps of a method according to the invention.

FIG. 3A shows a defect considered in a first example.

FIG. 3B is an example of an image resulting from simulated measurements of the defect shown in FIG. 3A.

FIG. 3C shows the classification performance of a neural network, considering measurements the signal-to-noise ratio of which is 5 dB (left), 20 dB (center), and 40 dB (right), respectively.

FIG. 3D shows the classification performance of a neural network according to the invention, considering measurements the signal-to-noise ratio of which is 5 dB (left), 20 dB (center), and 40 dB (right), respectively.

FIGS. 4A and 4B show a defect considered in a second example.

FIG. 4C shows the comparative classification performance:
of a reference neural network (curve a);
of an auxiliary neural network (curve b);
of a neural network according to the invention (curve c).

FIG. 5 schematically shows a variant of the invention.

### DESCRIPTION OF PARTICULAR EMBODIMENTS

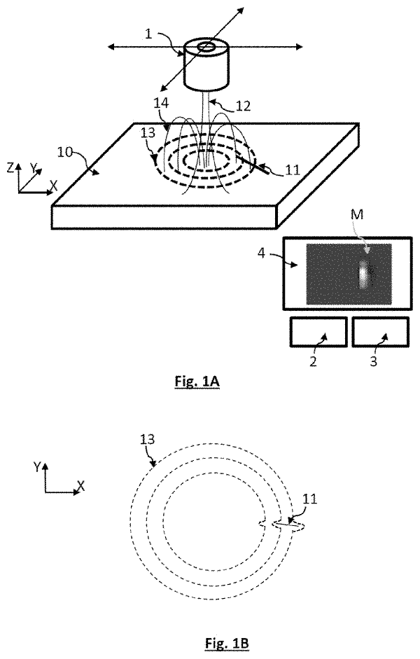

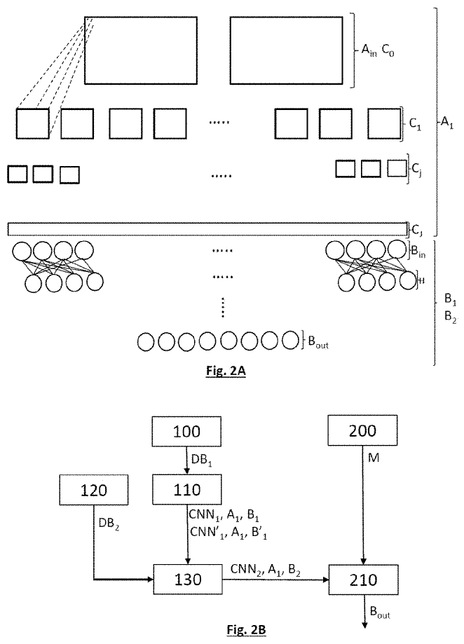

FIGS. 1A and 1B schematically show an example of application of the invention. A sensor 1 is placed facing a part 10 to be tested, so as to characterize the part. It may notably be a question of a thermal or mechanical characterization. By thermal or mechanical characterization, what is meant is a characterization of the thermal or mechanical properties of the part: temperature, deformation, structure.

The part to be characterized may be a monolithic part, or a more complex part resulting from assembly of a plurality of elementary parts, for example a lifting surface of an airplane wing or a skin of a fuselage.

The characterization may consist in detecting a potential presence of a structural defect 11. In this example, the sensor 1 is configured to perform measurements using eddy currents generated in the part 10 to be tested. The latter is an electrically conductive part. The principle of eddy-current-based non-destructive measurements is known. Under the effect of excitation by a magnetic field 12, eddy currents 13 are induced in the part 10. In the example shown, the sensor 1 is a coil, energized by an amplitude-modulated current. The coil generates a magnetic field 12, the field lines of which have been shown in FIG. 1A. Eddy currents 13 are induced, these forming current loops in the part 10. The eddy currents 13 generate a magnetic reaction field 14, the latter affecting the impedance of the coil 1. Thus, the measurement of the impedance of the coil 1 is representative of the eddy currents 13 formed in the part 10. In the presence of a defect 11, as schematically shown in FIG. 1B, the eddy currents 13 are modified, this resulting in a variation in the impedance of the coil. Thus, the measurement of the impedance of the coil constitutes a signature of the defect.

In this example, the sensor 1 is used to excite the part 10, and as sensor of the reaction of the part to the excitation. Generally, the sensor is moved along the part, parallel thereto. In the example shown, the part extends along an axis X and an axis Y. The sensor may be moved parallel to each axis, this having been represented by the double-headed arrows. Alternatively, a matrix array of sensors may be employed.

A series of measurements, forming a preferably two-dimensional spatial distribution of a measured quantity, in this case the impedance of sensor 1, is thus obtained. It is conventional to distinguish between the real and imaginary parts of the impedance. The measured impedance is generally compared to an impedance in the absence of defect, so as to obtain a map of the impedance variation ΔH. A measurement matrix M, representing the real part or the imaginary part of the impedance measured at each measurement point, may be formed.

The sensor 1 is connected to a processing unit 2, comprising a memory 3 containing instructions allowing implementation of a measurement-processing algorithm, the main steps of which are described below. The processing unit is usually a computer, connected to a display 4.

As described in connection with the prior art, the measurement matrix M corresponds to a spatial distribution of the response of the part to excitation, each measurement being a signature of the part. An inversion must be performed, so as to make it possible to conclude that a defect is present, and, where appropriate, to characterize the latter. The inversion is performed by the processing algorithm implemented by the processing unit 2.

By structural defect, what is meant is a mechanical defect affecting the part. It may notably be a question of a crack, or of a delamination, or of a perforation (for example forming a through-hole), or of a crack propagating from a hole, or of an abnormally porous region. The structural defect may also be a presence of an inclusion of an undesirable material, or of a corroded region. The structural defect may affect the surface of the part 10 located facing the sensor. It may also be located at depth in the part. The type of sensor used is selected depending on the defect to be characterized.

The part 10 to be tested may be formed from a composite. It then comprises components assembled with one another. It may be a question of an assembly of plates or of fibers. The defect may be an assembly defect: it may be a question of local delamination of plates, or of a decohesion of fibers or of fiber strands, or a non-uniformity in the orientation of fibers, or a defect resulting from an impact or shock.

The part 10 to be tested has mechanical properties that are spatially distributed along the part. The defect may be a variation in the spatial distribution of the mechanical properties with respect to a reference spatial distribution. It may for example be a question of one portion of the part, in which portion the mechanical properties do not correspond to reference mechanical properties, or are outside a range of tolerance. The mechanical property may be Young's modulus, or density, or a propagation speed of an acoustic wave. The reference spatial distribution may be obtained from a specification, and correspond to an objective to be achieved. It may result from a model or from experimental measurements.

The preceding paragraph also applies to electrical or magnetic properties, or even to a stress to which the part to be tested is exposed. It may for example be a question of a temperature-related stress or of a mechanical stress (a pressure-related stress for example) to which the part is subjected during its operation. Thus, the characterization of the part may consist in establishing a temperature of the part, or a level of mechanical stress (force, pressure, deformation) to which the part is subjected. The characterization may also consist in establishing a spatial distribution of a temperature of the part or, more generally, of a stress to which the part is subjected. The defect is then a divergence between the spatial distribution and a reference spatial distribution. When considering a spatial distribution of the temperature of the part, a defect may be the appearance of a hot spot, in which the temperature of the part is abnormally high with respect to a reference spatial distribution of temperature.

The characterization of the defect aims to determine the type of defect, among the aforementioned types. It may also comprise location of the defect, and estimation of all or some of its dimensions.

The measurements may be processed using a supervised artificial-intelligence algorithm, for example one based on a neural network. The algorithm may be trained by constructing a database formed from carried out or simulated measurements of a part comprising a defect the features of which are known: type of defect, dimensions, location, potentially porosity or another physical quantity allowing the defect to be characterized.

The database may be established by simulation, using a dedicated simulation software package. An example of a dedicated software package is the software package CIVA (supplier: Extende), which notably allows various non-destructive-testing techniques to be simulated: propagation of ultrasound, effects of eddy currents and X-ray radiography. Such a software package allows measurements to be simulated based on modeling of the part. Use of such a software package may allow a database to be constructed allowing the artificial-intelligence algorithm used to be trained.

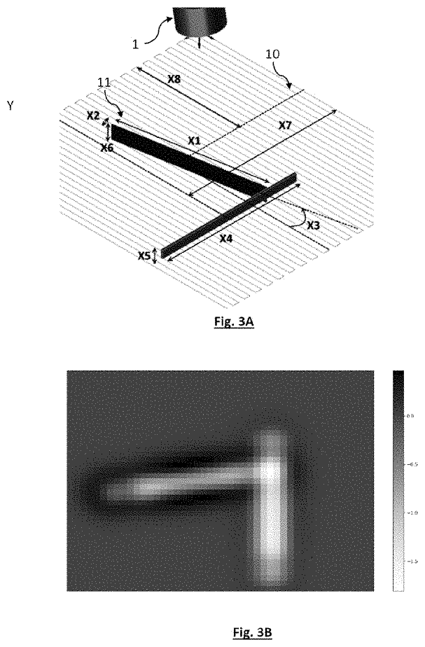

For this type of application, the inventors have concluded that use of a convolutional neural network is appropriate. Specifically, the input data are in matrix format and may be likened to images. Each image corresponds to a map of a measured physical quantity liable to vary in the presence of a defect in the part. FIG. 2A schematically shows the architecture of such a network.

The convolutional neural network comprises a feature-extracting block A₁, connected to a processing block B₁. The processing block is configured to process the features extracted by the extracting block A₁. In this example, the processing block B₁ is a classifying block. It allows a classification on the basis of the features extracted by the extracting block A₁. The convolutional neural network is fed with input data Aᵢₙ, which correspond to one or more images. In the example in question, the input data form an image obtained through concatenation of two images representing the real part and the imaginary part, respectively, of the impedance variation ΔH measured at various measuring points regularly distributed, facing the part, in a matrix-array arrangement.

The feature-extracting block A₁ comprises J layers C₁ . . . Cⱼ . . . C_{J} downstream of the input data. J being an integer higher than or equal to 1. Each layer Cⱼ is obtained by applying a convolution filter to the images of a previous layer Cⱼ₋₁. The index j is the rank of each layer. The layer C₀ corresponds to the input data Aᵢₙ. The parameters of the convolution filters applied in each layer are determined during training. The last layer C_{J} may comprise a number of terms exceeding several tens, or even several hundreds, or even several thousands. These terms correspond to features extracted from each image forming the input data.

Between two successive layers, the method may comprise dimension-reducing operations (pooling operations for example). It is a question of replacing the values of a group of pixels with a single value—for example the mean, or the maximum value, or the minimum value of the group in question. Max pooling, which corresponds to the replacement of the values of each group of pixels with the maximum value of the pixels in the group, may for example be applied. The last layer C_{J} is flattened, to make the values of this layer form a vector. These values constitute the features extracted from each image.

The classifying block B₁ is a fully connected neural network, or multilayer perceptron. It comprises an input layer Bᵢₙ, and an output layer Bₒᵤₜ. The input layer Bᵢₙ is formed by the features of the vector resulting from the extracting block A₁. Between the input layer Bᵢₙ and the output layer Bₒᵤₜ, one or more hidden layers H may be provided. The input layer Bᵢₙ, each hidden layer H and the output layer Bₒᵤₜ are thus placed in succession.

Each layer may be assigned a rank k. The rank k=0 corresponds to the input layer Bᵢₙ. Each layer comprises nodes, the number of nodes of a layer possibly being different from the number of nodes of another layer. Generally, the value of a node y_{n,k} of a layer of rank k is such that

$${y}_{n , k} = {f}_{n} ( {\sum }_{m} ( {w}_{m , n} {y}_{m , k - 1} + {b}_{m} ) )$$

where
y_{m,k-1} is the value of a node of the previous layer k−1, m being an order of the node of the previous layer, m being an integer comprised between 1 and Mₖ₋₁, Mₖ₋₁ corresponding to the dimension of the previous layer, of rank k−1;
bₘ is a bias associated with each node y_{m,k-1} of the previous layer;
fₙ is an activation function associated with the node of order n of the layer in question, n being an integer comprised between 1 and Mₖ, Mₖ corresponding to the dimension of the layer of rank k;
w_{m,n} is a weighting term for the node of order m of the previous layer (rank k−1) and the node of order n of layer in question (rank k).

The form of each activation function fₙ is determined by a person skilled in the art. It may for example be a question of an activation function fₙ of hyperbolic-tangent or sigmoid type.

The output layer Bₒᵤₜ contains values allowing a defect identified by the images of the input layer Aᵢₙ to be characterized. It is the result of the inversion performed by the algorithm.

In the simplest application, the output layer may comprise only a single node, taking the value 0 or 1 depending on whether the analysis reveals the presence or absence of a defect.

In an application to identification, the output layer may comprise as many nodes as there are types of defect to be identified, each node corresponding to a probability of presence of one type of defect among the predetermined types (crack, hole, delamination, etc.).

In an application to determining dimensions, the output layer may comprise as many nodes as there are dimensions of a defect, this assuming employment of a defect geometric model.

In an application to determining location, the output layer may comprise coordinates indicating the, two-dimensional or three-dimensional, position of a defect in the part.

In an application to characterization, the output layer may contain information on the inspected part, for example a spatial distribution of one or more mechanical properties (Young's modulus for example), or electrical or magnetic or thermal properties (temperature for example) or geometric properties (at least one dimension of the part for example). The dimension of the output layer corresponds to a number of points of the part at which the mechanical property is estimated on the basis of the input data.

These applications may be combined, so as to obtain both a location and dimensions, or a location, an identification and dimensions.

An important element of the invention is that the extracting block A₁ may be established, for a given measurement technique, using the most exhaustive possible training operation, called the first training operation, employing a large database. The classifying block may be tailored to various specific cases in which the measurement technique is implemented. In other words, the invention makes it possible to parametrize various classifying blocks B₁, B₂, for various applications, while preserving the same extracting block A₁.

Generally, in a first training phase, the extracting block A₁ and a first classifying block B₁ are parametrized. The first training phase is implemented using a first database DB₁, established in a first configuration, considering a first model part. The method comprises using a second database DB₂, on the basis of which a second training operation is performed. The second database is established in a second configuration different from the first configuration.

The first configuration is parametrized by various parameters Pᵢ, i being an integer identifying each parameter. These parameters may notably comprise:
P₁: the nature of the database: experimental data or simulated data, or simulated data with various levels of precision or fidelity;
P₂: shape of the model part in question;
P₃: material of the model part in question;
P₄: measurement conditions, for example acquisition time, position of the sensor with respect to the part, references of the sensor used or modeled, environmental parameters (temperature, humidity, possibly pressure), measurement noise, type of processing performed on the measurements to estimate a property of the part, whether it is a question of an electrical, magnetic or mechanical property;
P₅: type of defect in question;
P₆: location of the defect in the model part;
P₇: shape of the defect in question;
P₈: dimensions of the defect in question.

By fidelity, when mentioned in connection with the first parameter P₁, what is meant is an ability of the model to replicate reality.

The first database DB₁ contains various images representative of measurements of the first model part that were performed or simulated while varying certain parameters Pⱼ, called variable parameters, whereas other parameters P_{i≠j} remain fixed for all the images of the first database. For example, the first database DB₁ is constructed with only the parameter P₈, representing the dimensions of the defect in question, varying, the parameters P₁ to P₇ remaining constant.

It will be understood that, in each training operation, the features of the defect that it is sought to estimate are known. Generally, the variable parameters correspond to the features intended to be estimated by the neural network.

The first database DB₁ may contain a first number of images N₁ that may exceed several hundred or even several thousand. Thus, following the first training operation, the first neural network, formed by combination of blocks A₁ and B₁, is then assumed to have a satisfactory prediction performance.

One important element of the invention is the ability to use the first training operation to perform the second training operation, in a different configuration. By different configuration, what is meant is that at least one of the fixed parameters of the first configuration is modified. The following examples show various possibilities in respect of modification of a parameter:
Modification of the first parameter P₁: the second training operation is carried out considering experimental measurements, in-situ, whereas the first training operation is carried out considering measurements simulated or performed under laboratory conditions (or any other combination of experimental measurements and simulation). According to one possibility, the levels of precision of the first database DB₁ and of the second database DB₂ are different. For example, the first training operation and the second training operation are carried out based on measurements simulated with a low and high level of precision, respectively: the first database may be obtained using a first analytical model, which is fast but not very precise, whereas the second database may result from a numerical or stochastic semi-analytical model, which is slower to implement but more precise. Similarly, the first database may be obtained with a sensor that generates less precise measurements than the sensor used to construct the second database.

When the first and second databases are obtained experimentally, or by simulation, the number of sensors used (or simulated) may be different in the construction of each database.
Modification of the second parameter P₂: the second training operation is carried out considering a second model part, the shape of which is different from the first model part: the second model part may be rounded or curved while the first model part is planar. The first training operation may for example be performed on a model part the geometry of which is simple, easily modeled, or easy to manufacture. The second training operation may then be performed considering a part the geometry of which is more complex and that corresponds better to reality.
Modification of the third parameter P₃: the second training operation is carried out considering a second model part the material of which has a different composition to the first model part: it may for example be a question of a different alloy, or of a realistic alloy, having a certain variability with respect to a theoretical alloy considered in the first training operation. The same reasoning applies to a composite.
Modification of the fourth parameter P₄: the measurement conditions employed in the second training operation are different from those employed in the first training operation. For example, the position of the sensor with respect to the model part is different, or the temperature or humidity to which the sensor is exposed is different. The type of sensor may also be different. The second training operation may be performed taking into account a realistic sensor response, including measurement noise for example. The first database may be obtained using a sensor (or a simulation) affected by a noise and/or uncertainty level different from the sensor used to obtain the second database.
Modification of the fifth parameter P₅: the second training operation is carried out considering a number and/or type of defect different from that considered in the first training operation.
Modification of the sixth, seventh and eighth parameters P₆, P₇, P₈: the position, shape, or dimensions of the defect are modified in the second training operation, respectively.

Generally, the first training operation is carried out with certain parameters fixed. At least one of these parameters is modified in the second training operation, to construct the second database DB₂.

One important aspect of the invention is that, in the second training operation, the extracting block A₁ resulting from the first training operation is preserved. The first training operation is considered to be sufficiently exhaustive for the performance of the extracting block, in terms of extraction of features of the images supplied as input, to be considered sufficient. The extracting block may thus be used in the second training operation. In other words, the features extracted by the block A₁ are a good descriptor of the measurements forming the input layer.

The second training operation is thus limited to an update of the parametrization of the classifying block, to obtain a second classifying block B₂ tailored to the configuration of the second training operation. The second training operation may then be implemented with a second database DB₂ containing less data than the first database.

In the course of the second training operation, the second classifying block B₂ may be initialized taking into account the parameters governing the first classifying block B₁. According to one possibility, the second classifying block B₂ may comprise the same number of hidden layers as the first classifying block B₁. These hidden layers may possess the same number of nodes as the layers of the first classifying block. The dimension of the output layer depends on the features of the defect to be estimated. Thus, the dimension of the output layer of the second classifying block B₂ may be different from the dimension of the first classifying block B₁. According to one possibility, the number of hidden layers and/or the dimension of the hidden layers of the second classifying block is different from the number of hidden layers and/or the dimension of the hidden layers of the first classifying block.

The advantage of the invention is that, with a sufficiently complete first training operation, the second training operation may be carried out considering an amount of data significantly smaller than the amount of data used to carry out the first training operation. By significantly smaller amount of data, what is meant is at least 10 times or even 100 times less data. The second database DB₂, constructed to carry out the second training operation, is smaller than the first database DB₁. Frugal learning is spoken of, insofar as the amount of training data required is modest.

The method allows a first training operation to be implemented under laboratory conditions, on the basis of simulations or of optimized experimental conditions. This first training operation is followed by a second training operation that is closer to reality in the field: experimental measurements, and/or more realistic measurement conditions, or a part of more complex shape or construction are/is taken into account. The invention makes it possible to limit the number of measurements necessary for the second training operation, while allowing a neural network that has a good prediction performance to be obtained. This is an important advantage, since acquiring measurements under realistic conditions is usually more complex than obtaining measurements in the laboratory or simulated measurements. The second training operation may allow unmodelable specificities to be taken into account, for example measurement noise, or variations relative to the composition or to the shape of the part.

Another advantage of the invention is that it makes it possible to use a first training operation, carried out on a part made of a certain material, to perform a “frugal” second training operation on a similar part, of a different material.

The first training operation may be thought of as a general training operation, suitable for various particular applications, or for parts of various types or shapes, or for various types of defects. It is essentially intended to provide an extracting block A₁ allowing relevant features to be extracted from input data. The second training operation is more targeted, to a particular application, or to a particular type of part, or to a particular type of defect. The invention makes it easier to perform the second training operation, because it requires markedly less input data than the first training operation. Thus, the same first training operation may be used to perform various second training operations, corresponding to different configurations, respectively.

The first training operation may be carried out using a first database that is relatively easy to obtain, with respect to the second database. This makes it possible to provide a more exhaustive first database, for example reflecting a high degree of variability in the dimensions and/or in the shape of the defect.

The main steps of the invention are schematically shown in FIG. 2B.

Step 100: creating the first database DB₁.

In the course of this step, the first database DB₁ is built in a first configuration. As described above, the first configuration is parametrized by first parameters, some of these first parameters being fixed. The first database is formed from images representative of measurements obtained (performed or simulated) in the first configuration.

Step 110: first training operation.

In the course of this step, the first database is used to parametrize the blocks A₁ and B₁, so as to optimize the prediction performance of a first convolutional neural network CNN₁.

Step 120: creating the second database DB₂.

In the course of this step, the second database DB₂ is built in a second configuration. As described above, at least one parameter, considered fixed in the first configuration, is modified. The size of the second database is preferably at least 10 times smaller than the size of the first database.

Step 130: second training operation.

In the course of this step, the second database DB₂ is used to train a second convolutional neural network CNN₂ formed by the first extracting block A₁, resulting from the first training operation, and by a second classifying block B₂ specific to the configuration adopted in the second training operation.

The configuration relating to the second training operation may correspond to conditions considered to be close to the measurement conditions. Specifically, the convolutional neural network CNN₂ resulting from the second training operation is intended to be used to interpret measurements performed on the parts examined. This is the object of the following step.

Step 200: carrying out measurements.

Measurements are carried out, on an examined part, in the measurement configuration considered in the second training operation.

Step 210: interpreting the measurements.

The convolutional neural network CNN₂, resulting from the second training operation, is used to estimate the features of a defect potentially present in the examined part, based on the measurements performed in step 200. These features may be established using the output layer Bₒᵤₜ of the convolutional neural network CNN₂. This network is therefore used to perform the step of inverting the measurements.

### EXAMPLE 1

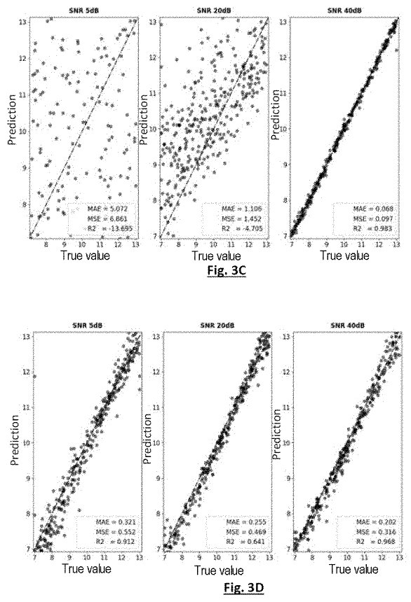

A first example of implementation of the invention will now be presented with reference to FIGS. 3A to 3D. FIG. 3A shows a simple defect, a T-shaped crack, having 7 positional or dimensional features:
the features X1, X2 and X4 are lengths or widths of two branches in a plane P_{XY},
the features X5 and X6 are depths of the two branches perpendicular to the plane P_{XY},
the feature X3 is an angular feature;
the features X7 and X8 are features in respect of the position of the defect in the plane P_{XY}.

Measurements performed using an eddy-current technique, in a scan consisting of 41×46 measurement points, at a distance of 0.3 mm above the part, were simulated. The part was a planar metal part. The light-gray line shown in FIG. 3A illustrates the movement of the sensor along the part, parallel to the plane P_{XY}. The image formed in FIG. 3B is an image of the real part of the impedance variation □H. The impedance variation corresponded to a difference, at each measurement point, between simulated impedances in the presence and in the absence of a defect in the part, respectively. FIG. 3B was obtained considering the following features: X1=11.822 mm; X2=0.086 mm; X3=−9.88°; X4=11.835 mm; X5=0.635 mm; X6=1.127 mm; X7=27.489 mm; X8=24.099 mm.

A first training operation was carried out on the basis of simulations. In the course of the first training operation, 2000 images were used taking into account a very low noise level (signal-to-noise ratio of 40 dB). Each input image was a concatenation of an image of the real part and of an image of the imaginary part of the impedance variation ΔH measured at each measurement point. In the course of this training operation, the dimensions of the defect were varied, its shape remaining the same.

The first training operation allowed a first convolutional neural network CNN₁, comprising a first extracting block A₁ and a first classifying block B₁ such as described above, to be parametrized. The input layer comprised two images, corresponding to the real part and to the imaginary part of the impedance variation □H at the various measurement points, respectively. The extracting block A₁ comprised four convolution layers C₁ to C₄ such that:
C₁ was obtained by applying 32 convolution kernels of 5×5 size to the two input images.
C₂ was obtained by applying 32 convolution kernels of 3×3 size to the layer C₁.
C₃ was obtained by applying 64 convolution kernels of 3×3 size to the layer C₂.

A maxpooling operation into groups of 2×2 pixels was performed between layers C2 and C3 and between layer C3 and layer C4, the latter being converted into a vector of 1024 size.

The vector of 1024 size obtained from the extracting block A₁ formed the input layer Bᵢₙ of a fully connected classifying block B₁ comprising a single hidden layer H (512 nodes), which was connected to an output layer Bₒᵤₜ. The latter was a vector that was 8 in size, each term corresponding to one estimate of the dimensions X1 to X8, respectively.

The first convolutional neural network CNN₁ was tested to estimate the 8 dimensional parameters X1 to X8 shown in FIG. 3A. In the test, simulated test images that were representative of experimental measurements having three signal-to-noise ratios (SNRs), 5 dB (low signal-to-noise ratio), 20 dB (average signal-to-noise ratio), and 40 dB (high signal-to-noise ratio), respectively, were used. In the test images, the various features X1 to X8 were varied. Signal-to-noise ratio was simulated by adding white Gaussian noise to the matrices (or images) forming the input layer of the neural network.

FIG. 3C shows the prediction performance in respect of the dimension X1 when test images the signal-to-noise ratio of which was 5 dB (left), 20 dB (center), 40 dB (right), respectively, were used. In each of the curves, the x-axis corresponds to the true values and the y-axis corresponds to the values estimated by the neural network CNN₁. It may be seen that prediction performance is unsatisfactory when the signal-to-noise ratio does not correspond to the signal-to-noise ratio considered in the training operation. In contrast, estimation performance is satisfactory when the signal-to-noise ratio corresponds to the signal-to-noise ratio considered in the training operation. In FIG. 3C, indicators relating to prediction performance have been indicated: mean absolute error (MAE), mean squared error (MSE) and coefficient of determination (R2).

The inventors trained a second neural network CNN₂, using, in a second database, 20 images simulated taking into account a signal-to-noise ratio of 40 dB and 20 images simulated taking into account a signal-to-noise ratio of 5 dB, i.e. a total of 40 images. As described above, the second neural network CNN₂ was parametrized while keeping the extracting block A₁ of the first neural network CNN₁. Only the classifying block B₂ of the second neural network was parametrized, while keeping the same number of layers and the same number of nodes per layer as the first neural network CNN₁.

The second neural network CNN₂ was tested on the same test data as the first neural network, i.e. with test images having signal-to-noise ratios equal to 5 dB, 20 dB and 40 dB, respectively. FIG. 3D shows the estimation performance of the second neural network, relative to the estimation of the first dimension X1. The format of FIG. 3D is identical to that of FIG. 3C: results for test images the signal-to-noise ratio of which was 5 dB (left), 20 dB (center) and 40 dB (right). The estimation performance is good whatever the signal-to-noise ratio in question.

This first example demonstrates the relevance of the invention: it allows a neural network to adapt rapidly when a second configuration is passed to from a first configuration by modifying a parameter kept fixed in the first configuration, in the present case the signal-to-noise ratio. It will be noted that the second neural network was parametrized using a database of 40 images, i.e. 50 times fewer than the database used during training of the first neural network.

### EXAMPLE 2

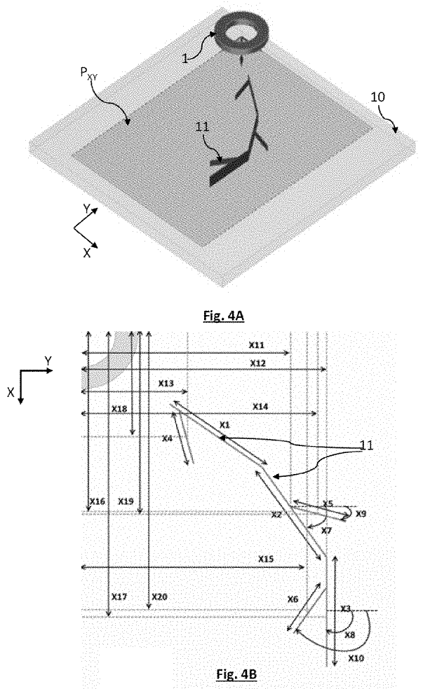

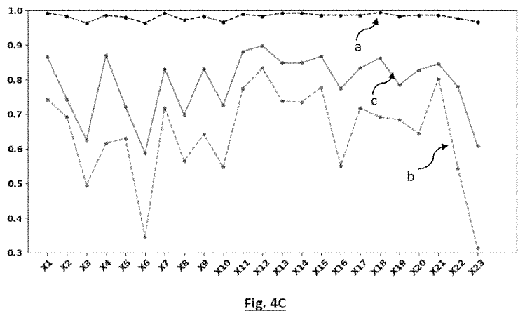

In a second example, the inventors went from a first training configuration, employing a defect of a first predetermined shape, to a second training configuration, based on a second shape different from the first shape. The second defect is shown in FIGS. 4A and 4B.

The complex second defect is a crack forming three Ts having 23 positional or dimensional features:
the features X1, X2, X3, X4, X5, X6 are branch lengths in a plane P_{XY};
the features X7, X8, X9 and X10 are angles in the plane P_{XY};
the features X11, X12, X13, X14, X15, X16, X17, X18, X19 and X20 are positional features;
the features X21, X22, X23 (not shown in FIG. 4B) are the thicknesses of each T perpendicular to the plane P_{XY}.

The inventors parametrized a reference neural network CNN_{ref}, by first constructing a reference database DB_{ref}. The reference database DB_{ref} contained 2000 images obtained by simulating measurements at 89×69 measurement points that were regularly distributed in a square grid, each image being obtained through concatenation of images of the real part and of the imaginary part of the impedance variation. The path of the sensor has been shown in FIG. 4A.

The reference neural network CNN_{ref} was a convolutional neural network, of an analogous structure to the neural networks CNN₁ and CNN₂ described in connection with the first example. The only differences were:
the dimension of the input layer, the latter comprising two images of 89×69 size, corresponding to the real part and to the imaginary part of the impedance variation ΔH, respectively;
the dimension of the output layer, which comprised 23 nodes, each node corresponding to an estimate of one dimension X1 to X23.

Curve (a) in FIG. 4C shows the obtained performance (coefficient of determination) in respect of estimation of the 23 dimensions when the reference neural network was used. The coefficients of determination relating to each dimension were computed by applying the reference neural network to 400 different defects. The obtained estimation performance was very good, this not being too surprising since the reference neural network was a network specifically designed for a defect of this shape.

The inventors compared the performance of the reference neural network with:
on the one hand, an auxiliary neural network obtained using a small database DBₐᵤₓ, established in the same way as the reference database DB_{ref}, but containing only 50 images, corresponding to 50 sets of different dimensions.
on the other hand, a neural network constructed according to the invention.

The small database DBₐᵤₓ was formed based on 50 different sets of features X1 . . . X23. The auxiliary neural network was parametrized using this small database. The structure of the auxiliary neural network was identical to the structure of the reference neural network CNN_{ref}. A plot of the obtained classification performance is given in FIG. 4C (curve b). Unsurprisingly, the classification performance was mediocre, as a result of the “under-training” of the auxiliary neural network. The coefficients of determination relating to each dimension were computed by applying the auxiliary neural network and the neural network according to the invention to 400 different defects.

The inventors formed a neural network according to the invention. To do this, a first neural network CNN1 was parametrized, using a first database DB₁ containing 2000 images resulting from simulations such as described in connection with the first example, on a “simple” defect such as shown in FIG. 3A. The size of each image was 89×69. The input layer was formed of two images, representing the real and imaginary parts of the impedance variation ΔH measured at 89×69 measurement points, respectively. Just as in example 1, the measurement points were regularly distributed in a square grid. To construct the first database, the dimensions X1 to X8 of the simple defect were varied.

The inventors then used the auxiliary database DBₐᵤₓ specific to the complex defect as second database DB₂, to parametrize a second neural network CNN₂, the latter using the extracting block A₁ of the first neural network CNN₁. Parametrization of the second neural network thus merely required parametrization of the classifying block B₂ of the second neural network CNN₂. The latter corresponded to a neural network according to the invention. The classifying block B₂ of the convolutional neural network CNN₂ was parametrized by modifying parameters that remained fixed during the construction of the extracting block A₁ of the first convolutional neural network CNN₁. In the present case, it was a question of the shape of the defect. Specifically, the extracting block A₁ of the first convolutional neural network CNN₁ was parametrized using a defect of simple shape (T-shaped defect shown in FIG. 3A), whereas the classifying block B₂ of the second convolutional neural network CNN₂ was parametrized using a different shape (complex defect comprising three Ts shown in FIG. 4B).

The second neural network CNN₂ was a neural network according to the invention. The inventors applied the second neural network to test images. The estimation performance of the neural network CNN₂ has been shown in FIG. 4C, curve (c). It may be seen that despite a training operation carried out with the same database as the auxiliary network, i.e. a frugal database, the obtained classification performance was better than that obtained with the auxiliary neural network. This confirms the advantage of the invention.

### Variant 1

In the preceding examples, the input data of the neural networks consisted of matrices resulting from simulations of measurements performed using the eddy-current technique. The invention may be applied to other techniques usually employed in the field of non-destructive testing, provided that the input data takes matrix form, i.e. a form comparable to an image. More precisely, other envisionable techniques are:
Ultrasonic testing, in which an acoustic wave propagates through an examined part. This encompasses echography, in which the measurements are generally representative of reflection, by a defect, of an incident ultrasonic wave. This also encompasses propagation of guided ultrasonic waves. In this type of technique, the physical quantities addressed are the properties of propagation of ultrasonic waves through the material, the presence of a defect resulting in a variation in the properties of propagation with respect to a part in the absence of a defect. It is possible to obtain images representative of the propagation of an ultrasonic wave along or through a part.
X-ray or gamma-ray testing, in which the examined part is irradiated with ionizing electromagnetic radiation. The presence of a defect results in a modification of the transmission properties of the radiation. The measurements allows images representative of the transmission of the radiation through the examined part to be obtained.
Thermographic testing, in which the examined part is irradiated with electromagnetic radiation in the infrared spectral band. The presence of a defect results in a modification of the reflection properties of the radiation. The measurements allow images representative of the reflection of the radiation by the examined part to be obtained.
Testing based on measurements of the propagation parameters of a bending wave through the part. In such a technique, transducers are placed on the part, each transducer being configured to emit or detect a bending wave propagating through the plate. The propagation parameters of the wave (in particular group velocity and/or amplitude) depend on the elastic properties of the part, and notably on its density and its Young's modulus. The density and Young's modulus of the part depend on its temperature. Thus, the propagation parameters of the bending wave allow the temperature of the part to be estimated. When various piezoelectric transducers are placed at points around one portion of the part, a plurality of emitter/detector pairs may be defined. It is then possible to estimate a temperature spatial distribution in the portion of the part bounded by the transducers, using reconstruction algorithms known to those skilled in the art. The defect may be an anomaly in the temperature spatial distribution with respect to a reference spatial distribution.

### Variant 2

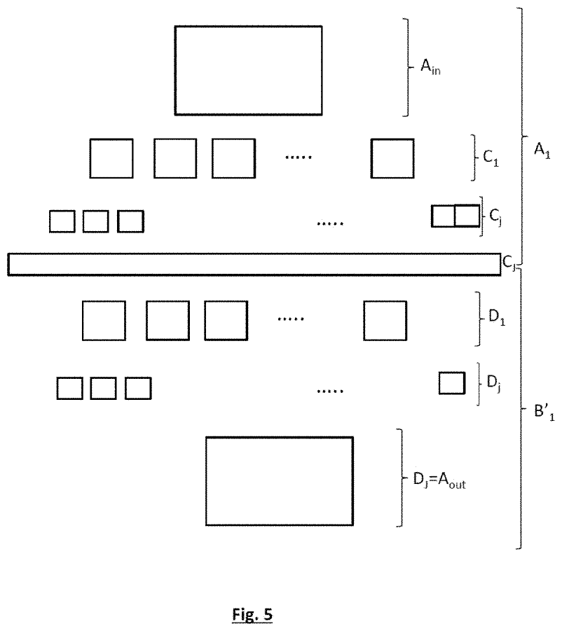

According to another variant, in the first training operation, a first extracting block A₁ coupled to a reconstructing block B′₁ is employed. Just like the first classifying block B₁ described above, the reconstructing block B′₁ is a block for processing the data extracted by the first extracting block A₁. In this variant the first neural network CNN′₁ is an autoencoder. As shown in FIG. 5, the first neural network comprises the extracting block A₁ and the reconstructing block B′₁.

In a manner known to those skilled in the art, an autoencoder is a structure comprising an extracting block A₁ (called the encoder) that allows relevant information to be extracted from input data Aᵢₙ, defined in an input space. The input datum is thus projected into a space, called the latent space. In the latent space, the information extracted by the extracting block is called code. The autoencoder comprises a reconstructing block B′₁, allowing the code to be reconstructed, so as to obtain an output datum Aₒᵤₜ, defined in a space that is generally identical to the input space. Training is performed in such a way as to minimize an error between the input datum Aᵢₙ and the output datum Aₒᵤₜ. Following training, the code, extracted by the extracting block, is considered to be representative of the main features of the input data. In other words, the extracting block A1 allows the information contained in the input data Aᵢₙ to be compressed.

The first neural network may notably be a convolutional autoencoder: each layer of the extracting block A₁ results from application of a convolution kernel to a previous layer. FIG. 5 shows the convolution layers C₁ . . . Cⱼ . . . C_{J}, layer C_{J} being the last layer of the extracting block A₁, comprising the code. FIG. 5 also shows the layers D₁ . . . Dⱼ . . . D_{J} of the processing block B′₁, layer D_{J} corresponding to the output datum Aₒᵤₜ.

Unlike the classifying block B₁ described above, the reconstructing block B′₁ is not intended to determine the features of a defect. The reconstructing block allows the output data Aₒᵤₜ to be reconstructed, based on the code (layer C_{J}), the reconstruction being as faithful as possible to the input datum Aᵢₙ. The classifying block B₁ and the reconstructing block B′₁ are used for the same purpose: to allow parametrization of the first extracting block A₁, the latter then being able to be used during the second training operation, to parametrize the second classifying block B₂.

In this variant, the method follows steps 100 to 210 described above with reference to FIG. 2B. The first training operation (step 110) consists in parametrizing the extracting block A₁. It may be performed on the basis of at least a first database. Use of an autoencoder allows various first databases to be combined. Certain databases are representative of healthy defect-free parts, whereas other databases are representative of parts with a defect. For example, it is possible to combine:
databases collating measurements performed on a healthy part, at various temperatures, with a view to learning the effect of a temperature variation on the measurements;
databases collating measurements performed on a part comprising a defect, at a constant temperature, with a view to learning the effect of the presence of a defect on the measurements.

Combining various databases, representative of different situations, to perform the first training operation allows a data-extracting block to be obtained that concentrates the useful information of each image.

Following training, steps 120 to 210 are performed as described above. It is a question of performing a second training operation, on the basis of the second database, so as to parametrize a classifying block B₂, using the extracting block A₁ resulting from the first training operation.

1. A method for characterizing a part, the part being liable to comprise a defect, the method comprising the following steps:
a) carrying out non-destructive measurements using a sensor, the sensor being placed on the part or facing the part;
b) forming at least one measurement matrix using the measurements performed in step a);
c) using the matrix as input datum of a convolutional neural network, the convolutional neural network comprising:
an extracting block, configured to extract features from each input datum;
a classifying block, configured to classify the features extracted by the extracting block, the classifying block outputting to an output layer comprising at least one node;
d) depending on the value of each node of the output layer, detecting the presence of a defect in the part, and potentially characterizing the detected defect;
the method comprising, prior to steps c) and d):
constructing a first database, the first database comprising performed or simulated measurements, of a first model part, in a first configuration, the first configuration being parametrized by parameters, chosen from:
type of measurement: experimental or simulated;
shape of the model part;
material forming the model part;
measurement conditions;
type of defect in question;
location of the defect in the model part;
shape of the defect in the model part;
at least one dimension of the defect of the model part;
the first database being formed considering at least one of said variable parameters and at least one of said fixed parameters, the first database comprising measurements performed or simulated in the presence of the defect in the model part;
employing a first neural network, comprising an extracting block and a processing block, the processing block being configured to process features extracted by the extracting block, the first neural network having been the subject of a first training operation, using the first database;
wherein the method further comprises:
constructing a second database, comprising performed or simulated measurements of a second model part that is representative of the characterized part, in a second configuration, the second configuration being parametrized by modifying at least one fixed parameter of the first configuration;
a second training operation, using the second database, so as to configure a second convolutional neural network, the second convolutional neural network comprising the extracting block of the first neural network, and a classifying block, the latter being configured in the second training operation;
such that in step c), the neural network used is the second convolutional neural network, resulting from the second training operation.

2. The method as claimed in claim 1, wherein the processing block of the first neural network is a classifying block, configured, in the first training operation, to perform a classification of the features extracted by the extracting block, the first neural network being a convolutional neural network.

3. The method as claimed in claim 2, wherein, in the second training operation, the classifying block of the second neural network is initialized using the classifying block of the first neural network.

4. The method as claimed in claim 1, wherein the first neural network is an autoencoder, said processing block of the first neural network being configured, in the first training operation, to reconstruct data obtained from the first database, and forming input data of the first neural network.

5. The method as claimed in claim 1, wherein the defect is of the following type: delamination, and/or crack, and/or perforation and/or crack propagating from a perforation and/or presence of a porous region and/or presence of an inclusion and/or presence of corrosion.

6. The method as claimed in claim 1, wherein the part is made of a composite, comprising components assembled with one another, wherein the defect is an assembly defect between the components.

7. The method as claimed in claim 1, wherein the measurements are representative of a spatial distribution:
of electrical or magnetic or mechanical properties of the part;
and/or of dimensions of the part;
and/or of properties of propagation of an acoustic or mechanical or electromagnetic wave through or along the part;
and/or of properties of reflection of an acoustic or mechanical or visible or infrared electromagnetic wave by the part;
and/or of properties of transmission of an X-ray or gamma-ray electromagnetic wave by the part;
and/or of a temperature of the part.

8. The method as claimed in claim 7, wherein the defect is a variation in spatial distribution with respect to a reference spatial distribution.

9. The method as claimed in claim 1, wherein the measurements are of the following type:
measurements of eddy currents formed in the part under the effect of excitation of the part by a magnetic field;
or measurements of acoustic or mechanical waves propagating through or along the part;
or measurements of the reflection of infrared or visible light when the part is illuminated by infrared or visible light;
or measurements of the transmission of X-ray or gamma radiation through the part when said part is irradiated by a source of X-ray or gamma radiation.

10. The method as claimed in claim 1, wherein:
the first database is constructed from simulated measurements;
and the second database is formed from measurements performed experimentally;
or
the first database is constructed from measurements performed experimentally;
and the second database is formed from simulated measurements;
or
the first database and the second database are constructed from simulated measurements;
or
the first database and the second database are constructed from experimental measurements.

11. The method as claimed in claim 1, wherein the measurement conditions comprise at least:
position of the sensor with respect to the model part and/or number of sensors;
temperature and/or humidity and/or environmental conditions under which the sensor is employed;
surface finish of the inspected part;
measurement noise level;
type of sensor used;
uncertainties associated with the measurements.

12. The method as claimed in claim 1, wherein the first model part and the second model part are identical.

13. The method as claimed in claim 1, wherein:
the second model part has a different shape to the first model part;
and/or the second model part is formed from a different material to the first model part.

14. The method as claimed in claim 1, wherein the second database comprises a lower number of data than the number of data of the first database.

15. The method as claimed in claim 1, wherein the characterization of the defect comprises:
identification of the type of defect, among predetermined types;
and/or estimation of at least one dimension of the defect;
and/or location of the defect in the part;
and/or determination of a number of defects in the part.
